(19) United States
(12) Patent Application Publication
(10) Pub. No.: US 2021/0209519 A1
(43) Pub. Date: Jul. 8, 2021

(54) SYSTEM AND METHODS FOR VEHICLE ZONE MANAGEMENT

(71) Applicant: Flow, Inc., New York, NY (US)

(72) Inventors: Jacob Peter BASKIN, Brooklyn, NY (US); Dawn Michelle MILLER, Brooklyn, NY (US); Stephen Nicholas SMYTH, New York, NY (US)

(21) Appl. No.: 17/141,614

(22) Filed: Jan. 5, 2021

Related U.S. Application Data
(60) Provisional application No. 62/958,640, filed on Jan. 8, 2020.

(51) Int. Cl. G06Q 10/02; H04L 29/08; G06F 16/23; G01S 19/51

(52) U.S. Cl. CPC G06Q 10/02; G01S 19/51; G06F 16/2379; H04L 67/18

(57) ABSTRACT

A method for reserving a vehicle dwelling zone includes receiving a request from a first user via a software application, and selecting (e.g., automatically), via the software application and based on the request, an available vehicle dwelling zone. The vehicle dwelling zone can include, for example, a curb space, an alley space, a private driveway, or a parking garage. The software application reserves (e.g., automatically) at least a portion of the selected vehicle dwelling zone for occupancy of a vehicle, by causing storage, in a memory operably coupled to the software application, of a reservation record including an association between the first user and the selected vehicle dwelling zone. The at least the portion of the selected vehicle dwelling zone can be reserved for a user-configurable hold period of A second user can be alerted, via the software application, of the reservation record.

### RELATED APPLICATIONS

This application claims priority to and benefit of U.S. Provisional Patent Application No. 62/958,640, filed Jan. 8, 2020 and titled “System and Methods for Vehicle Loading Zone Management,” the entire disclosure of which is hereby incorporated by reference herein in its entirety.

### TECHNICAL FIELD

Embodiments described herein relate generally to systems and methods of managing vehicle dwelling zones.

### BACKGROUND

Embodiments described herein relate generally to systems and methods of managing dwelling spaces for vehicles. Vehicle loading zones and management thereof present several challenges and obstacles. Loading and unloading of goods in public or private spaces is often unorganized and/or unregulated. As an example, delivery trucks often resort to double parking (i.e., parking parallel to a vehicle already at a curb), thus creating traffic jams and a general lack of safety. A space that can serve dozens of cars, trucks, buses, or bicycles suddenly becomes unusable due to the blockage caused by the delivery truck. Also, nearby pedestrians can be hidden from view by the obstruction of the delivery truck, and bicyclists can be forced to move into more dangerous parts of the road (i.e., away from bicycle lanes). In other words, double parking can cause both convenience issues and safety issues. Additionally, short term loading and unloading is often done without paying, thus reducing revenue for the municipality or private entity owning the curb space. Delivery truck drivers can also lose large amounts of time searching for areas to load or unload goods. Adding organization to the loading and unloading process, and generally to vehicle dwelling zone management can significantly reduce the occurrence of these problems.

### SUMMARY

The present disclosure describes systems and methods for vehicle zone management. In some embodiments, a method for reserving a vehicle dwelling zone includes receiving a request from a first user via a software application, and selecting (e.g., automatically), via the software application and based on the request, an available vehicle dwelling zone. The vehicle dwelling zone can include, for example, a curb space, an alley space, a private driveway, or a parking garage. The software application reserves (e.g., automatically) at least a portion of the selected vehicle dwelling zone for occupancy of a vehicle, by causing storage, in a memory operably coupled to the software application, of a reservation record including an association between the first user and the selected vehicle dwelling zone. The at least the portion of the selected vehicle dwelling zone can be reserved for a user-configurable hold period of, for example, up to about 10 minutes. A second user can be alerted, via the software application, of the reservation record. The method can also include sending, via the software application and after the reserving, a reservation confirmation message to a compute device of the first user.

In some embodiments, a system includes a processor and a memory in communication with the processor. The memory stores processor-executable instructions for reserving a vehicle dwelling zone, the instructions including instructions to cause the processor to receive, via a software application, a request from a first user, and to select, via the software application and based on the request, an available vehicle dwelling zone. The instructions also include instructions to cause the processor to reserve, via the software application, at least a portion of the selected vehicle dwelling zone for occupancy of a vehicle, by storing, in a memory operably coupled to the software application, a reservation record including an association between the first user and the selected vehicle dwelling zone. The instructions also include instructions to cause the processor to alert a second user, via the software application, of the reservation record.

In some embodiments, a non-transitory processor-readable storage medium stores processor-executable instructions for reserving a vehicle dwelling zone. The processor-executable instructions include instructions to cause a processor to receive, via a software application, a request from a first user, and to select, via the software application and based on the request, an available vehicle dwelling zone. The processor-executable instructions also include instructions to cause a processor to reserve, via the software application, at least a portion of the selected vehicle dwelling zone for occupancy of a vehicle, by storing, in a memory operably coupled to the software application, a reservation record including an association between the first user and the selected vehicle dwelling zone, and to alert a second user, via the software application, of the reservation record.

### BRIEF DESCRIPTION OF THE DRAWINGS

FIG. 1 is a block diagram of a method of reserving a smart zone, according to an embodiment.

FIG. 2 is a flowchart illustrating a smart zone manager and components included in a process of reserving a smart zone, according to an embodiment.

### DETAILED DESCRIPTION

Embodiments described herein relate generally to systems and methods of vehicle zone management. In some embodiments, a vehicle dwelling zone can be reservable via a software application. In some embodiments, a vehicle dwelling zone reservable via a software application can be referred to as a “smart zone.” Smart zones can be used for short-duration purposes (also referred to herein as “short-dwell”), such as loading and unloading and for short periods of time, or for long duration purposes (also referred to herein as “long-dwell”), such as parking. Short-dwell use can be, for example, for a duration of up to about 30 minutes, while long dwell use can be, for example, for a duration of at least about 30 minutes. The use of smart zones for short-dwell and long-dwell purposes can alleviate many of the aforementioned double parking issues, and can generally promote efficient management of vehicle dwelling spaces within a geographic region (e.g., a city, a district), as can the centralized management of the smart zones (e.g., based on real-time data collected from distributed sensors, cameras, etc.). Centralized management of the smart zones can further reduce booking errors, as well the computational resources used in ascertaining the availability of vehicle dwelling spaces and booking them. Moreover, some embodiments of the present disclosure (e.g., including smart zone enforcement functionality) increase the likelihood of user adoption of the associated software application, increase user confidence in the security of the system (e.g., keeping out bad actors), and prevent drivers from holding a vehicle dwelling zone for an extended period without using it, thereby promoting efficient usage of vehicle dwelling zones.

As described above, double parking can cause significant traffic and safety issues. High incidence of double parking can be an indication that curb usage is not being adequately or properly regulated. Changes to curb or alley regulations are often implemented as a reaction to complaints, safety concerns, and/or traffic accidents, rather than proactively. As a result, existing regulations can be outdated and not reflective of current usage trends of these vehicle dwelling spaces. The increasing use of online delivery services (and their associated deliveries) has further compounded problems related to double parking and other misuse of vehicle dwelling spaces. Parcel delivery, e-commerce delivery, and internet-based food delivery (e.g., Grubhub and Uber Eats) are all examples of online delivery services. Cities (and other zone-hosting entities) have generally been slow to adjust to the changing commercial landscape, and how that affects vehicle dwelling spaces. Implementation of the smart zones described herein can provide cities and other zone-hosting entities with real-time information about usage of vehicle dwelling zones, with increased accuracy over existing usage monitoring techniques, and can facilitate the visualization of how usage of these smart zones is changing in real time. Cities can then adjust regulations quickly and regularly to match demand in each particular area.

Smart zones of the present disclosure can also be used to address difficulties cities have in monetizing non-parking usage of curbs and other vehicle dwelling zones. A significant percentage of revenue generated for cities comes from parking meter fares and parking ticket expenses. However, loading and unloading, particularly of delivery trucks, often involves a short dwell with the driver of the vehicle near the vehicle during the entire dwelling period. Parking enforcement officers are often reluctant to write tickets when the driver or another occupant of the vehicle is inside the vehicle or in the vehicle's immediate vicinity. The potential revenue generated by the use of designated smart zones or smart dwelling spaces can incentivize the replacement of pay parking with smart zones. Ease of access of smart zones and smart zone software can create a more appealing product for curb users. As noted above, trucks often double park, risking parking tickets and injury to themselves and others. There is currently a lack of incentive for drivers to locate true (i.e., authorized) loading zones, since parallel parking a truck can be difficult and time consuming. Additionally, drivers sometimes choose to dwell relatively far from their destination due to a lack of viable space near the destination. The further a driver parks from the destination, the further they have to carry cargo by hand, and the longer the truck dwells in the vehicle dwelling space. Smart zones described herein can offer a positive experience for drivers such that they may prefer using smart zones over double parking, in view of the increased convenience, reduced safety risk, and reduced parking violation risk of the smart zones.

In some embodiments, a “smart zone manager” can organize and regulate one or more smart zones. In some embodiments, a smart zone can include a loading/unloading zone, a ride-hail zone, a micromobility parking zone, a passenger vehicle parking zone, and/or any other short term or long term vehicle dwelling zone. In some embodiments, the smart zone can include a long-dwell vehicle zone, such as a parking space. In some embodiments, the smart zone manager includes one or more software applications (“apps”) configured to access a memory or other storage device. In some embodiments, the smart zone manager includes a user-facing software application (e.g., a driver-facing software application for use by vehicle drivers), a hosting application (e.g., a software application for use by one or more administrators associated with a zone-hosting entity), an enforcement application (e.g., for use by an enforcement officer when enforcing usage of the smart zones), and/or any other suitable software application for use by any parties involved. In some embodiments, the software applications can be accessible via and/or implemented using a computer, a computing device, a laptop, a mobile device, a tablet, an application programming interface (“API”), a software development kit (“SDK”), or any other suitable interface. Software applications set forth herein can be programmed to include (and, optionally, automatically update in response to changes in) curb regulations (e.g., regulations issued by local government), land use data, local statistics about traffic and/or parking violations, traffic data, pricing data, bus speed data, and/or any other data pertinent to vehicle dwelling zone management. In some embodiments, one or more software applications can be incorporated into pre-existing software applications, systems, or compute devices of vehicle fleets using the smart zone manager. In some implementations, participating vehicle fleets may not use a driver app on an ongoing basis. In some embodiments, a separate driver app may be preferable, such as during an early stage of a program implementing a smart zone manager. Based on data stored in or by the smart zone manager, any app included in the smart zone manager may be configured to identify spaces or geographic regions in which adding more smart zones would be practical, or where the management of existing smart zones can be improved (e.g., to provide more loading space).

In some embodiments, a user of the smart zone manager includes a driver (or a vehicle operator in the case of a driverless vehicle), a fleet owner, a fleet manager, a fleet organizer, and/or any other entity seeking to use a smart zone. In some embodiments, a zone-hosting entity using the smart zone manager includes a city, a municipality, a private real estate manager, a land owner, an owner of a space designated as a smart zone, a lessor of a space designated as a smart zone, a school, a university, an airport, a warehouse, a conference center, or any other entity that can host a vehicle dwelling zone. In some embodiments, outreach to nearby residents, local businesses, community organizations, elected officials, and/or community boards can be performed to educate the public about the smart zone program and to create avenues for feedback. In some embodiments, enforcement of smart zone usage can be carried out by police departments and/or local parking enforcement units. Protocols for enforcement can be developed and implemented to ensure that law enforcement professionals understand the rules for the smart zones and their role in enforcing these rules.

As used in this specification, the singular forms “a,” “an,” and “the” include plural referents unless the context clearly dictates otherwise. Thus, for example, the term “a zone” is intended to mean a single zone or a combination of zones, “an application” is intended to mean one or more applications, or a combination thereof.

As used herein, the term “set” and “plurality” can refer to multiple features or a singular feature with multiple parts. Thus, a set of portions or a plurality of portions may include multiple portions that are either continuous or discontinuous from each other.

As used herein, “vehicle dwelling zone” or “vehicle dwelling space” can refer to any space where an operator of a vehicle volitionally stops movement of a vehicle. This can include, but is not limited to, a curb space, an alley space, a loading/unloading zone, a driveway, a private street, a field, and a parking space. A vehicle dwelling zone or vehicle dwelling space can refer to a space intended for a long dwell (e.g., parking space) or a short dwell (e.g., loading or unloading zone).

As used herein, “smart zone manager” can refer to a system that includes one or more computing devices and software applications to manage and/or regulate the usage of a smart zone. As an example, a smart zone manager can include a computing device, a data storage device (e.g., a cloud server), a driver application, a hosting application, and an enforcement application.

As used herein, a “fleet” can refer to a plurality of vehicles operating together and/or under the same ownership or management. In some embodiments, a fleet can include a group of vehicles that are not centrally owned or managed, such as a group of vehicles operating under a common platform.

As used herein, a “vehicle” can refer to a commercial vehicle and/or a privately owned vehicle.

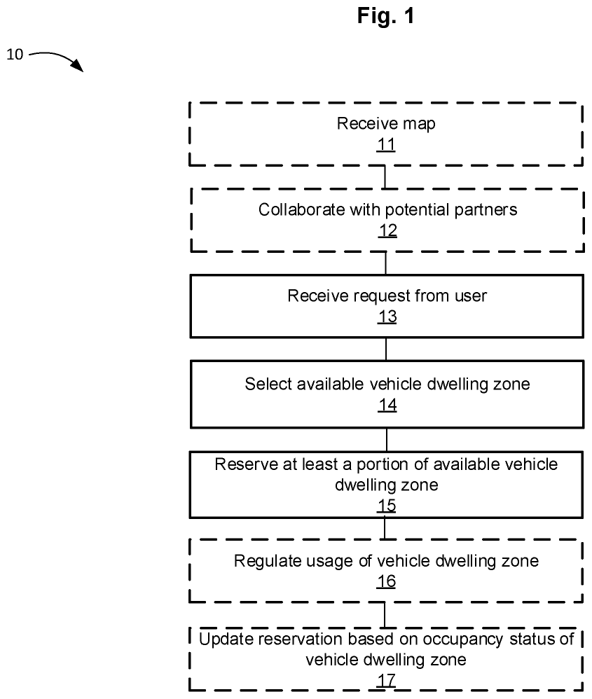

FIG. 1 is a block diagram of a method 10 of reserving a smart zone, according to an embodiment. The method 10 optionally includes receiving a map at step 11 and collaborating with potential partners at step 12. The method 10 includes receiving a request from a user at step 13, selecting an available vehicle dwelling zone at step 14, and reserving at least a portion of the available vehicle dwelling zone at step 15. The method 10 optionally includes regulating usage of the vehicle dwelling zone at step 16 and updating the reservation based on occupancy status of the vehicle dwelling zone at step 17.

At step 11, a map is optionally received and saved in a memory or other data storage device for subsequent use, e.g., during the reserving of the smart zone. In some embodiments, the map can include a map of a city, a municipality, a plot of real estate, a district, and/or any other geographic region or portion of land suitable for reservation as a smart zone. In some embodiments, the map can include, and can be automatically and/or dynamically updated to include, indications of available vehicle dwelling spaces and indications of reserved (i.e., unavailable) vehicle dwelling spaces. In some embodiments, the map can be updated regularly or semi-regularly (e.g., automatically) to reflect changes in geography (e.g., newly built roads). In addition, in some embodiments, the map can include representations of curb regulations (e.g., regulations issued by local government), land use data, local statistics about traffic and/or parking violations, traffic data, bus speed data, and/or any other data pertinent to vehicle dwelling zone management, such that this data can be taken into account when reserving dwelling zones and/or defining smart zones.

The method 10 can include designating one or more vehicle dwelling spaces as smart zones. In some embodiments, the map can include the smart zones pre-programmed. In some embodiments, the smart zones can be designated at locations on the map such as curbs, alleys, private driveways, private fields, public fields, parking lots, parking lot areas, loading docks, after curb cuts, after fire hydrants, parking zones, no-parking zones, loading zones, unloading zones, apartment building driveways, parking garages, airports, and/or any other suitable vehicle dwelling space. In some embodiments, smart zones can be designated based on proximity to busy intersections. In other words, busy intersections can be avoided when designating smart zones. In some embodiments, designating no-parking zones as smart zones can make it easier for large trucks to pull into zones and create more flexibility to ensure curb space is available. In some embodiments, a program designating vehicle dwelling zones as smart zones can identify a location as promising, and the zone-hosting entity (e.g., the city) can perform further vetting and/or site visits to determine whether or not to designate the vehicle dwelling zone as a smart zone. In some embodiments, the zone-hosting entity can consider factors, such as what enforcement resources are available, and what stakeholders are nearby.

In some embodiments, the smart zone can be on pavement, asphalt, dirt, grass, gravel, sand, concrete, or any other suitable dwelling area. In some embodiments, the smart zone can have a length dimension of at least about 2 car lengths, at least about 3 car lengths, at least about 4 car lengths, at least about 5 car lengths, at least about 6 car lengths, at least about 7 car lengths, at least about 8 car lengths, at least about 9 car lengths, at least about 10 car lengths, at least about 15 car lengths, at least about 20 car lengths, or at least about 25 car lengths. In some embodiments, the smart zone can have a length dimension of no more than about 30 car lengths, no more than about 25 car lengths, no more than about 20 car lengths, no more than about 15 car lengths, no more than about 10 car lengths, no more than about 9 car lengths, no more than about 8 car lengths, no more than about 7 car lengths, no more than about 6 car lengths, no more than about 5 car lengths, no more than about 4 car lengths, or no more than about 3 car lengths. Combinations of the above-referenced lengths of the smart zone are also possible (e.g., at least about 2 car lengths and no more than about 30 car lengths or at least about 3 car lengths and no more than about 10 car lengths), inclusive of all values and ranges therebetween. In some embodiments, the smart zone can have a length dimension of about 2 car lengths, about 3 car lengths, about 4 car lengths, about 5 car lengths, about 6 car lengths, about 7 car lengths, about 8 car lengths, about 9 car lengths, about 10 car lengths, about 15 car lengths, about 20 car lengths, about 25 car lengths, or about 30 car lengths.

In some embodiments, the smart zone can have a length of at least about 30 feet, at least about 45 feet, at least about 60 feet, at least about 75 feet, at least about 90 feet, at least about 105 feet, at least about 120 feet, at least about 135 feet, at least about 150 feet, at least about 225 feet, at least about 300 feet, or at least about 375 feet. In some embodiments, the smart zone can have a length of no more than about 450 feet, no more than about 375 feet, no more than about 300 feet, no more than about 225 feet, no more than about 150 feet, no more than about 135 feet, no more than about 120 feet, no more than about 105 feet, no more than about 90 feet, no more than about 75 feet, no more than about 60 feet, or no more than about 45 feet. Combinations of the above-referenced lengths of the smart zone are also possible (e.g., at least about 30 feet and no more than about 450 feet or at least about 45 feet and no more than about 150 feet), inclusive of all values and ranges therebetween. In some embodiments, the smart zone can have a length of about 30 feet, about 45 feet, about 60 feet, about 75 feet, about 90 feet, about 105 feet, about 120 feet, about 135 feet, about 150 feet, about 225 feet, about 300 feet, about 375 feet, or about 450 feet.

In some embodiments, the smart zone can have a length of at least about 10 meters, at least about 15 meters, at least about 20 meters, at least about 25 meters, at least about 30 meters, at least about 35 meters, at least about 40 meters, at least about 45 meters, at least about 50 meters, at least about 75 meters, at least about 100 meters, or at least about 125 meters. In some embodiments, the smart zone can have a length of no more than about 150 meters, no more than about 125 meters, no more than about 100 meters, no more than about 75 meters, no more than about 50 meters, no more than about 45 meters, no more than about 40 meters, no more than about 35 meters, no more than about 30 meters, no more than about 25 meters, no more than about 20 meters, or no more than about 15 meters. Combinations of the above-referenced lengths of the smart zone are also possible (e.g., at least about 10 meters and no more than about 150 meters or at least about 15 meters and no more than about 50 meters), inclusive of all values and ranges therebetween. In some embodiments, the smart zone can have a length of about 10 meters, about 15 meters, about 20 meters, about 25 meters, about 30 meters, about 35 meters, about 40 meters, about 45 meters, about 50 meters, about 75 meters, about 100 meters, about 125 meters, or about 150 meters.

In some embodiments, the smart zone can have a width of at least about 1 car width, at least about 2 car widths, at least about 3 car widths, at least about 4 car widths, at least about 5 car widths, at least about 6 car widths, at least about 7 car widths, at least about 8 car widths, or at least about 9 car widths. In some embodiments, the smart zone can have a width of no more than about 10 car widths, no more than about 9 car widths, no more than about 8 car widths, no more than about 7 car widths, no more than about 6 car widths, no more than about 5 car widths, no more than about 4 car widths, no more than about 3 car widths, or no more than about 2 car widths. Combinations of the above-referenced car widths are also possible (e.g., at least about 1 car width and no more than about 10 car widths or at least about 2 car widths and no more than about 6 car widths), inclusive of all values and ranges therebetween. In some embodiments, the smart zone can have a width of about 1 car width, about 2 car widths, about 3 car widths, about 4 car widths, about 5 car widths, about 6 car widths, about 7 car widths, about 8 car widths, about 9 car widths, or about 10 car widths.

In some embodiments, the smart zone can have a width of at least about 10 feet, at least about 20 feet, at least about 30 feet, at least about 40 feet, at least about 50 feet, at least about 60 feet, at least about 70 feet, at least about 80 feet, or at least about 90 feet. In some embodiments, the smart zone can have a width of no more than about 100 feet, no more than about 90 feet, no more than about 80 feet, no more than about 70 feet, no more than about 60 feet, no more than about 50 feet, no more than about 40 feet, no more than about 30 feet, or no more than about 20 feet. Combinations of the above-referenced feet are also possible (e.g., at least about 10 feet and no more than about 100 feet or at least about 20 feet and no more than about 60 feet), inclusive of all values and ranges therebetween. In some embodiments, the smart zone can have a width of about 10 feet, about 20 feet, about 30 feet, about 40 feet, about 50 feet, about 60 feet, about 70 feet, about 80 feet, about 90 feet, or about 100 feet.

In some embodiments, the smart zone can have a width of at least about 3 meters, at least about 6 meters, at least about 9 meters, at least about 12 meters, at least about 15 meters, at least about 18 meters, at least about 21 meters, at least about 24 meters, or at least about 27 meters. In some embodiments, the smart zone can have a width of no more than about 30 meters, no more than about 27 meters, no more than about 24 meters, no more than about 21 meters, no more than about 18 meters, no more than about 15 meters, no more than about 12 meters, no more than about 9 meters, or no more than about 6 meters. Combinations of the above-referenced meters are also possible (e.g., at least about 3 meters and no more than about 30 meters or at least about 6 meters and no more than about 20 meters), inclusive of all values and ranges therebetween. In some embodiments, the smart zone can have a width of about 3 meters, about 6 meters, about 9 meters, about 12 meters, about 15 meters, about 18 meters, about 21 meters, about 24 meters, about 27 meters, or about 30 meters.

Upon receipt of the map and designation of smart zones, the method 10 optionally further includes collaboration with one or more potential partners, at step 12. In some embodiments, recruitment of collaborators can include outreach in the geographic region of the smart zones. In some embodiments, the recruitment can be done virtually (e.g., via mobile phones, social media, email, etc.). In some embodiments, partners or collaborators can include fleets of commercial vehicles. Given the high value of reliable, reservable loading zones, partner fleets have incentive to join in using a smart zone manager. In some embodiments, the zone-hosting entity can recruit fleets as collaborative partners. In some embodiments, partners can be representative of large, small, local, and/or global fleet operators. Examples of possible partner fleets would include the NYS Motor Truck Association or Together for Safer Roads.

In some embodiments, partner fleets can be split into categories (e.g., commercial loading, parcel delivery, etc.). In some embodiments, a given smart zone can be available to all vehicles and/or fleets in a given category. In some embodiments, a given smart zone can be available only to a specific entity (i.e., an entity purchases exclusive rights to the use of a zone). In some embodiments, an entity can have exclusive rights to the use of a smart zone, such that the entity does not have to reserve the smart zone. In some embodiments, collaborating partners can receive smart zone locations and operating times via the smart zone manager and the driver application. In some embodiments, private fleets can be incentivized to participate in using the smart zone manager, as they can receive extra space for their vehicles upon joining. In other words, introductory bonuses can be provided to incentivize private entities to use the smart zone manager and collaborate with the zone-hosting entity.

At step 13, the smart zone manager receives a request from the user (e.g., via a signal sent from a compute device of the user, via an app, to a host compute device). In some embodiments, the request can be transferred from the user (i.e., the driver) to the smart zone manager via the driver application. In some embodiments, the request can include a list of constraints or criteria the user has for the smart zone to be reserved. For example, the user may request a smart zone between the blocks of 8^{th} Street and 14^{th} Street and 3^{rd} Avenue and 4^{th} Avenue, and facing north. Upon receipt of the request, the smart zone manager analyzes the map and the available smart zones on the map. The smart zone manager then selects one or more available vehicle dwelling zones at step 14, based on the user's constraints. The user can then view the available dwelling zones that meet the user's criteria via the driver application. In some embodiments, the user can view locations of both traditional vehicle dwelling zones and smart zones. In some embodiments, the user can see availability information for smart loading zones. In some embodiments, the user can select a smart zone from a set of smart zones. In other words, the user can view, via the driver application, multiple vehicle dwelling zones, and can select one or more vehicle dwelling zones for reservation from the multiple vehicle dwelling zones.

At step 15, the smart zone manager reserves at least a portion of an available smart zone. In some embodiments, the reservation can be for a time period that is selected by the user via the driver application. In some embodiments, the smart zone can be reserved for a time period that is determined automatically based on detecting a presence and absence of the vehicle in the smart zone. In some embodiments, reserving at least a portion of the available smart zone can include placing a hold on the smart zone and then executing the booking upon arrival of the vehicle at the smart zone. In some embodiments, the booking can be executed in advance of the vehicle arriving at the smart zone. In some embodiments, the user can execute payment upon booking or reserving. In some embodiments, the user can execute payment upon arrival at the smart zone. In some embodiments, the user can book and check into a smart zone based on the user's location. In some embodiments, a reservation confirmation message can be sent to a compute device (e.g., mobile phone, tablet) of the user. In some embodiments, the driver app can automatically check into the smart zone as soon as the user (and/or the user's mobile device or vehicle) is within a threshold distance of the smart zone. In some embodiments, the threshold distance can be less than about 500 feet, less than about 400 feet, less than about 300 feet, less than about 200 feet, less than about 100 feet, less than about 50 feet, less than about 40 feet, less than about 30 feet, less than about 20 feet, or less than about 10 feet.

In some embodiments, a smart zone can be large enough to accommodate multiple vehicles. In some embodiments, step 15 can include reserving a first portion of the smart zone for occupancy of a first vehicle and reserving a second portion of the smart zone for occupancy of a second vehicle. In some embodiments, a single smart zone can be booked for occupancy by 2, 3, 4, 5, 6, 7, 8, 9, 10, or at least 10 vehicles. A number of vehicles and/or the combination of types of vehicles that can book a given smart zone for a given time period can be determined, prior to the reserving, based on one or more dimensions (e.g., lengths) of the vehicles. For example, a given smart zone may be sized and/or shaped to accommodate three delivery vans or only one tractor-trailer.

In some embodiments, conservative assumptions and/or limitations can be employed when booking a smart zone. In other words, an upper limit can be placed on the percentage of smart zones within a given geographic region that can be booked. This upper limit can account for unaffiliated or illegal use of smart zones, unregulated parking, or unregulated standing/idling in smart zones. In some embodiments, the upper limit of smart zones booked in a given geographical region can be at least about 50%, at least about 55%, at least about 60%, at least about 65%, at least about 70%, at least about 75%, at least about 80%, at least about 85%, at least about 90%, at least about 95%, at least about 96%, at least about 97%, or at least about 98%. In some embodiments, the upper limit of smart zones booked in a given geographical region can be no more than about 99%, no more than about 98%, no more than about 97%, no more than about 96%, no more than about 95%, no more than about 90%, no more than about 85%, no more than about 80%, no more than about 75%, no more than about 70%, no more than about 65%, no more than about 60%, or no more than about 55%. Combinations of the above-referenced values of the upper limit of smart zones booked in a given geographical region are also possible (e.g., at least about 50% and no more than about 99% or at least about 60% and no more than about 80%), inclusive of all values and ranges therebetween. In some embodiments, the upper limit of smart zones booked in a given geographical region can be about 50%, about 55%, about 60%, about 65%, about 70%, about 75%, about 80%, about 85%, about 90%, about 95%, about 96%, about 97%, about 98%, or about 99%.

In some embodiments, an upper limit can be placed on the area-percentage of a smart zone that can be booked. For example, if a single smart zone has a width of 10 feet and a length of 120 feet (i.e. an area of 1200 square feet) an upper limit of 900 square feet, or 75% of the area of the single smart zone can be bookable, while 25% remains unbooked. In some embodiments, the upper limit placed on the area-percentage of a single smart zone that can be booked can be at least about 50%, at least about 55%, at least about 60%, at least about 65%, at least about 70%, at least about 75%, at least about 80%, at least about 85%, at least about 90%, at least about 95%, at least about 96%, at least about 97%, or at least about 98%. In some embodiments, the upper limit placed on the area-percentage of a single smart zone that can be booked can be no more than about 99%, no more than about 98%, no more than about 97%, no more than about 96%, no more than about 95%, no more than about 90%, no more than about 85%, no more than about 80%, no more than about 75%, no more than about 70%, no more than about 65%, no more than about 60%, or no more than about 55%. Combinations of the above-referenced upper limits placed on the area-percentage of a single smart zone that can be booked are also possible (e.g., at least about 50% and no more than about 99% or at least about 60% and no more than about 80%), inclusive of all values and ranges therebetween. In some embodiments, the upper limit placed on the area-percentage of a single smart zone that can be booked can be about 50%, about 55%, about 60%, about 65%, about 70%, about 75%, about 80%, about 85%, about 90%, about 95%, about 96%, about 97%, about 98%, or about 99%. In some embodiments, a user's profile on the driver app can indicate the type and/or size of the vehicle the user has. In some embodiments, the percentage of a smart zone that can be reserved takes into account the sizes of the vehicles that have reserved space in the smart zone.

In some embodiments, the upper limit of smart zones booked in a given geographical region and/or the upper limit placed on the area-percentage of a smart zone that can be booked can be modified based on the time of the day, the time of the week, the time of the month, and/or the time of the year. For example, the upper limit can be lower during rush hour than at midnight to account for more vehicles standing at or near the smart zones. In some embodiments, the driver app can be configured to generate alerts and/or reports to indicate that the smart zones in a geographic region are at or near capacity, and optionally send a signal to cause presentation (e.g., display) of the alerts and/or reports via a graphical user interface (GUI) of a compute device on which the driver app is running. In some embodiments, a buffer can be placed before and/or after each smart zone reservation to account for overstays. For example, a reservation record can include a representation of one or multiple buffer durations, one or multiple buffer start times and/or one or multiple buffer end times. In some embodiments, the buffer can be at least about 1 minute, at least about 2 minutes, at least about 3 minutes, at least about 4 minutes, at least about 5 minutes, at least about 6 minutes, at least about 7 minutes, at least about 8 minutes, at least about 9 minutes, at least about 10 minutes, at least about 15 minutes, at least about 20 minutes, at least about 25 minutes. In some embodiments, the buffer can be no more than about 30 minutes, no more than about 25 minutes, no more than about 20 minutes, no more than about 15 minutes, no more than about 10 minutes, no more than about 9 minutes, no more than about 8 minutes, no more than about 7 minutes, no more than about 6 minutes, no more than about 5 minutes, no more than about 4 minutes, no more than about 3 minutes, or no more than about 2 minutes. Combinations of the above-referenced buffers are also possible (e.g., at least about 1 minute and no more than about 30 minutes or at least about 10 minutes and no more than about 20 minutes), inclusive of all values and ranges therebetween. In some embodiments, the buffer can be about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, or about 30 minutes. Over time, public awareness and/or parking enforcement can improve the efficiency of the usage of these smart zones, such that these buffers can be shorter.

In some embodiments, the zone hosting entity can collaborate with fleets to aid in determining appropriate booking windows. Some loading zones can be more physically suited to serve long dwell reservations, while some loading zones can be more physically suited to serve short dwell reservations. For example, loading zones in back alleys away from traffic can be suited to serve long dwell reservations. In some embodiments, loading zones suited to serve long dwell reservations can employ larger buffers than short dwell loading zones. In some embodiments, the rollout phase of the smart zone manager can include a first usage phase with long-dwell reservation based loading only, followed by experimenting with expansion to other usage phases that are not as sensitive to reliability after long-dwell usage has been adopted and stabilized. In some embodiments, the zone-hosting entity can modify pricing, time limits, and user groups (i.e., lists of fleets allowed to use certain smart zones) from the hosting application. In some embodiments, changes to pricing, time limits, and user groups can be reflected in the driver app without having to change signage. In some embodiments, limits on smart zone usage can be changed based on construction and/or other special circumstances and can be adapted to the needs of areas surrounding the smart zones. In some embodiments, the limits can be changed based on drivers' ability to know whether a zone is available for use prior to arriving.

In some embodiments, the booking at step 15 can include alerting other users of the booked status of the smart zone. For example, the user can be a first user, and the smart zone manager can alert a second user, via the driver app of the booked status of the smart zone. In some embodiments, users can enable active alerts when a smart zone in a given geographic region is booked. In some embodiments, users can be alerted, via the driver application, when a smart zone in a given geographic region is booked. In some embodiments, users can see via the driver app that a smart zone is booked in real-time with minimal delay after the booking occurs. In some embodiments, real-time information about the smart zone can be transmitted to users. In some embodiments, the real-time information can include availability information, price information, terms, conditions, and/or information about loading zones proximate to the smart zone.

In some embodiments, “reserving” can refer to generating or modifying records in a table or other repository. For example, a reservation record can be one of many reservation records noted in a repository or ledger. Table 1 shows an example of such a ledger. As shown, each reservation can have a reservation number associated with it. In some embodiments, the driver making the reservation can have an associated username. In some embodiments, each user can have one or more vehicles associated with his/her account. In some embodiments, if a user has multiple vehicles associated with his/her account, the reserving can include selecting which of the associated vehicles the reservation is for. In some embodiments, each vehicle registered with the smart zone manager can have an associated vehicle ID. In some embodiments, the associated vehicle ID can be assigned by the smart zone manager. In some embodiments, the associated vehicle ID can include the license plate number of the vehicle. In some embodiments, each smart zone can have an associated smart zone number. In some embodiments, each smart zone number can include a city code indicating the city where the smart zone is located (e.g., NYC=New York City, BOS=Boston). In some embodiments, each smart zone can include a designation of whether the smart zone is a short-dwell zone, a long dwell zone, or unspecified. In some embodiments, a reservation record can include a starting date and time. In some embodiments, if a driver occupies a smart zone without reserving, the reservation can automatically begin upon detecting the vehicles presence in the smart zone. For example, reservation 5446412 in Table 1 may have begun when the vehicle was initially detected in the smart zone (i.e., 7:03 AM) and with no definite end time. In some embodiments, the ledger can include the cost of the reservation. In some embodiments, the cost can be calculated retroactively based on how long the vehicle occupied the smart zone (e.g., reservation 5446412 in Table 1). In some embodiments, a reservation record can include an ending date and time. In some embodiments, the ledger can include a buffer period for the beginning of the reservation. In some embodiments, the ledger can include a buffer period for the end of the reservation. Some reservations can be absent of any buffer designation (e.g., 5446412 and 5446413).

TABLE 1
Example section of repository of reservation records

| | | | | Smart | Dwelling | Reservation | Reservation | | Beginning | | Ending |
|---|---|---|---|---|---|---|---|---|---|---|---|
| Reservation | | | | Zone | Zone | Start | End | | Buffer | | Buffer |
| Number | Username | Vehicle ID | Vehicle Type | Number | Type | Date/Time | Date/Time | Cost | Period | | Period |
| 5446410 | JSmith95 | NY345SG1 | Ford F350 | NYC3381 | Short- | May 1, | May 1, | $80 | 1 | minute | 2 minutes |
| | | | | | Dwell | 2022 13:00 | 2022 13:20 | | | | |
| 5446411 | SJonesTruck | MA254TL4 | Mack | BOS8775 | Short- | May 1, | May 1, | $30 | 4 | minutes | 5 minutes |
| | | | Class 7 | | Dwell | 2022 11:00 | 2022 11:30 | | | | |
| 5446412 | Driver2000 | 15596 | Peterbilt | MIA5481 | Long- | May 1, | None | TBD | None | | None |
| | | | 567 | | Dwell | 2022 7:03 | | | | | |
| 5446413 | StanWu100 | IL248549 | Ford | CHI2163 | Long- | May 2, | May 1, | $100 | None | | None |
| | | | Econoline | | Dwell | 2022 9:30 | 2022 10:30 | | | | |
| 5446414 | Kelly559 | 945551 | Hino 338 | LON7441 | Not | May 1, | May 1, | $30 | 5 | minutes | 5 minutes |
| | | | | | Specified | 2022 15:20 | 2022 15:30 | | | | |
| 5446415 | Parker081 | 8744763 | Peterbilt | HOU9168 | Short- | May 4, | May 4, | $20 | 10 | minutes | 3 minutes |
| | | | 579 | | Dwell | 2022 13:00 | 2022 13:10 | | | | |

The method 10 optionally includes regulating usage of the vehicle dwelling zone at step 16. After finalizing desired locations to be used as smart zones, the zone-hosting entity can proceed to have the smart zones formally approved and or legislated (i.e., as part of a formal smart zone program). Formal approval can be applied for and granted digitally/electronically (i.e., via transmission of electronic documents/signatures) and/or formal approval can be applied for and granted via signing of physical documents. Once approved, the zone-hosting entity can proceed to implement and regulate usage of smart zones by installing or changing signage at selected smart zone locations. In some embodiments, signage can include language indicating the reserved nature of the vehicle dwelling space, such as “no stopping except for authorized vehicles.” In some embodiments, smart zones can be absent of any physical signage indicating the status of the smart zone as a reservable vehicle dwelling zone. In some embodiments, smart zones can be indicated by curb paint, road stencils, flexible delineators, traffic cones, traffic cylinders, or any other appropriate smart zone indication media. In some embodiments, analytics from the hosting app can be used for scheduling and regulating smart zone usage. In some embodiments, regulations can be defined based on time and purpose of use. In some embodiments, one or more vehicle dwelling spaces can include a sign that does not indicate its use as a smart zone or that does not indicate who is authorized to park there (e.g., the sign may read “no stopping” or “no stopping except for authorized vehicles”), and a user can determine whether the one or more vehicle dwelling spaces are available to him/her using the smart zone manager.

In some embodiments, a smart zone can be regulated to have a first purpose of use during a first time period and a second purpose of use during a second time period. In some embodiments, the first purpose and/or the second purpose can include goods loading. In some embodiments, the first purpose and/or the second purpose can include goods dropoff. In some embodiments, the first purpose and/or the second purpose can include passenger loading. In some embodiments, the first purpose and/or the second purpose can include passenger dropoff. For example, a smart zone can be regulated for goods (e.g., freight, bulk goods) loading during the day and passenger loading during the evening. In some embodiments, purpose of use and time period partitioning regulations can be implemented via the enforcement app and/or the hosting application. In some embodiments, the time blocks to be regulated for a specific purpose can have minimum and/or maximum length of time. In some embodiments, the first time period and/or the second time period can be at least about 5 minutes, at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 12 hours, at least about 14 hours, at least about 16 hours, or at least about 18 hours. In some embodiments, the first time period and/or the second time period can be no more than about 20 hours, no more than about 18 hours, no more than about 16 hours, no more than about 14 hours, no more than about 12 hours, no more than about 10 hours, no more than about 9 hours, no more than about 8 hours, no more than about 7 hours, no more than about 6 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, or no more than about 10 minutes.

In some embodiments, regulations of smart zone usage can be stored virtually via cloud storage, such that they can be easily and readily changed by zone-hosting entities and readily viewed by anyone with an internet connection. In some embodiments, physical signs can be posted near the smart zones to indicate the existence of time regulations as well as the reserved status of the smart zone, and/or hours of operation. In some embodiments, upon reserving the smart zone, the user can send, via the driver application, a signal representing the information to the sign for display on the sign. In some embodiments, physical signage can include digital displays in communication with cloud data. In some embodiments, signage can indicate where to find more information about the driver application.

In some embodiments, the smart zone manager can be designed to remove as many regulatory impediments as possible, such that the zone-hosting entity can experiment with different mixes and patters of regulations across a wide variety of smart zones. In some embodiments, usage of the smart zones can be enforced by police department. In some embodiments, usage of the smart zones can be enforced by the zone-hosting entity. In some embodiments, a third-party agency can be employed to enforce the usage of the smart zones. As described above, smart zones can be indicated by curb signage, paint, flexible delineators, traffic cones, and/or traffic cylinders. Such indications can signal that the space is unavailable to non-users. In some embodiments, program-branded signage and/or legal “no stopping” signs can indicate that the space is a special zone. In some embodiments, matching branded decals can be provided to participating vehicles.

In some embodiments, smart zones can be patrolled by enforcement officers working in the field. In some embodiments, enforcement officers can use an enforcement application. In some embodiments, the enforcement app can include a mobile application, a computer application, a software application, or any other suitable type of application. In some embodiments, the enforcement app can include license plate recognition to assess whether vehicles are parked in smart zones legally or illegally. In some embodiments, enforcement officers can receive special training to enforce smart zone usage. In some embodiments, enforcement officers can be trained via laminated program briefs to remind enforcement officers of protocols of a given zone. In some embodiments, enforcement officers can receive memo books to remind enforcement officers of protocols of a given zone. In some embodiments, enforcement officers can send enforcement data (e.g., a violation report) to the smart zone manager. In some embodiments, an associated reservation record can be updated to include the enforcement data.

In some embodiments, a violation can be detected automatically. For example, if a vehicle not participating in the smart zone manager program parks in a smart zone, this violation can be detected automatically. In some embodiments, the detection of a non-participating vehicle in the smart zone can be via a camera. In some embodiments, the detection of the non-participating vehicle in the smart zone can be via a computer vision technique. In some embodiments, the license plate of the vehicle can be automatically detected and recognized via camera and/or computer vision technique.

In some embodiments, the driver app can include a feature to report if a space is full. In some embodiments, the driver app can indicate which nearby spaces have availability. Occupancy info can be useful for overall monitoring of the smart zone manager program and the occupancy info can be transmitted to enforcement officers for their response. In some embodiments, enforcement of smart zone usage can include an initial period of warnings that precedes monetary fines. In some embodiments, a booking status of a smart zone can be communicated to an enforcement officer. In some embodiments, the enforcement officer can issue a ticket if a user overstays a reservation or otherwise abuses the smart zone management system. Alternatively or in addition, an electronic ticket can be generated in response to detecting an overstay, and a notification can be sent to the user to indicate that a fee is due for the overstay. This can improve public education of the smart zone manager program and prevent community backlash. In some embodiments, a condition of participation in the smart zone manager program can be agreeing to internal program penalty structure for overstays in a smart zone beyond a grace period. In some embodiments, the grace period can be at least about 1 minute, at least about 2 minutes, at least about 3 minutes, at least about 4 minutes, at least about 5 minutes, at least about 10 minutes, at least about 15 minutes, at least about 20 minutes, or at least about 25 minutes. In some embodiments, the grace period can be no more than about 30 minutes, no more than about 25 minutes, no more than about 20 minutes, no more than about 15 minutes, no more than about 10 minutes, no more than about 9 minutes, no more than about 8 minutes, no more than about 7 minutes, no more than about 6 minutes, no more than about 5 minutes, no more than about 4 minutes, no more than about 3 minutes, or no more than about 2 minutes. Combinations of the above-referenced grace periods are also possible (e.g., at least about 1 minute and no more than about 30 minutes or at least about 10 minutes and no more than about 20 minutes), inclusive of all values and ranges therebetween. In some embodiments, the grace period can be about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, or about 30 minutes.

In some embodiments, the zone-hosting entity can receive analytics and access to program data. In some embodiments, the zone hosting entity can access reservation requests, unmet demand information, and/or loading zone usage information from participating fleets. In some embodiments, the zone-hosting entity can access reports of problems reported to the smart zone manager via the driving app, the enforcement app, and/or via the manager app. In some embodiments, the zone-hosting entity can access revenue data via the hosting application. In some embodiments, the analytics can include input from participating fleets, including fleet drivers using the application. These analytics can assist with program refinement, monitoring, and evaluation.

Traditional parking legislation includes specific, fixed regulations set by a governing body. Smart zone-enabling legislation may give a Director of Transportation or other organizer the ability to adjust parameters and rules of smart zone usage to better achieve the goals of the smart zones. In some embodiments, outer bounds of parameters to be adjusted can be set by a governing board. In some embodiments, demand-responsive pricing can be implemented.

At step 17, the method 10 optionally includes updating the reservation based on occupancy status of a vehicle dwelling zone. In some embodiments, detection of the vehicle in the smart zone can be performed automatically via GPS. In some embodiments, the detection of the vehicle in the smart zone can be via transmission of a wireless signal to the smart zone manager from a dongle of the vehicle. In some embodiments, the wireless signal can be via Bluetooth, 5G, and/or radio frequency. In some embodiments, the wireless signal can include an identifier of the vehicle. In some embodiments, the detection of the vehicle in the smart zone can be via a camera. In some embodiments, the detection of the vehicle in the smart zone can be via a computer vision technique. In some embodiments, the license plate of the vehicle can be recognized via camera and/or computer vision technique. In some embodiments, payment can be initiated via detection of the vehicle in the smart zone. In some embodiments, detection of the vehicle for payment can be via either of the aforementioned detection method. In some embodiments, a record or indication that the smart zone is occupied can be stored or transmitted via the software application.

In some embodiments, the smart zone is reserved for a hold period. In other words, the driver has until the beginning of the reservation time, plus the hold period to arrive at the smart zone. For example, if the reservation begins at 1:00 PM, and the hold period is 5 minutes, the driver has until 1:05 PM to arrive at the smart zone before the reservation is canceled. In some embodiments, the holding includes updating a record associated with the selected smart zone in a memory. In some embodiments, the holding can occur prior to the arrival of the vehicle in the smart zone and the reservation can be executed upon detecting arrival of the vehicle in the selected smart zone. In some embodiments, the hold period can be at least about 1 minute, at least about 2 minutes, at least about 3 minutes, at least about 4 minutes, at least about 5 minutes, at least about 6 minutes, at least about 7 minutes, at least about 8 minutes, or at least about 9 minutes. In some embodiments, the hold period can be no more than about 10 minutes, no more than about 9 minutes, no more than about 8 minutes, no more than about 7 minutes, no more than about 6 minutes, no more than about 5 minutes, no more than about 4 minutes, no more than about 3 minutes, or no more than about 2 minutes. Combinations of the above-referenced values for the hold period are also possible (e.g., at least about 1 minute and no more than about 10 minutes or at least about 4 minutes and no more than about 8 minutes), inclusive of all values and ranges therebetween. In some embodiments, the hold period can be about 1 minute, about 2 minutes, about 3 minutes, about 4 minutes, about 5 minutes, about 6 minutes, about 7 minutes, about 8 minutes, about 9 minutes, or about 10 minutes. In some embodiments, the hold period can be user-configurable. For example, the user can select whether the user prefers a hold period of 2 minutes, 3 minutes, 4 minutes, etc.

In some embodiments, step 17 can include updating a reservation record to remove an association between the user and the selected vehicle dwelling zone in response to not detecting the vehicle in the smart zone during the hold period. In some embodiments, the reservation record can be updated in response to detecting the vehicle in the smart zone during the hold period. In some embodiments, the reservation record can be updated to remove an association between the user and the smart zone in response to not detecting a vehicle in the smart zone during the hold period. In some embodiments, the detecting can be done automatically via GPS. In some embodiments, the reservation record can be updated to reflect that the selected smart zone has been reserved for a period of time beyond the hold period. In some embodiments, data can be collected and transmitted to the smart zone manager indicating a percentage of time in which the smart zone is reserved. In some embodiments, data can be collected and transmitted to the smart zone manager indicating a percentage of time in which the smart zone is occupied. In some embodiments, data can be collected and transmitted to the smart zone manager indicating time periods in which the smart zone is reserved. In some embodiments, data can be collected and transmitted to the smart zone manager indicating time periods in which the smart zone is occupied.

In some embodiments, the booking at step 15 can be for a specified time period. In some embodiments, the reservation period can be extended, via the driver app based on detection of the vehicle in the smart dwelling zone beyond the specified time period. In some embodiments, detection of the vehicle in the smart zone can be performed automatically via GPS. In some embodiments, the detection of the vehicle in the smart zone can be via transmission of a wireless signal to the smart zone manager from a dongle of the vehicle. In some embodiments, the wireless signal can be via Bluetooth, 5G, and/or radio frequency. In some embodiments, the wireless signal can include an identifier of the vehicle. In some embodiments, the detection of the vehicle in the smart zone can be via a camera. In some embodiments, the detection of the vehicle in the smart zone can be via a computer vision technique. In some embodiments, the license plate of the vehicle can be recognized via camera and/or computer vision technique.

At step 17, the method 10 optionally includes updating the reservation based on detection of a departure of the vehicle from the smart zone. In some embodiments, detection of the vehicle's departure from the smart zone can be performed automatically via GPS. In some embodiments, the detection of the vehicle's departure from the smart zone can be via transmission of a wireless signal to the smart zone manager from a dongle of the vehicle. In some embodiments, the wireless signal can be via Bluetooth, 5G, and/or radio frequency. In some embodiments, the wireless signal can include an identifier of the vehicle. In some embodiments, the detection of the vehicle's departure from the smart zone can be performed (e.g., automatically) using one or more of: a camera, computer vision or other artificial intelligence (AI) technology (e.g., object detection, object tracking, and/or optical character recognition), a magnetometer, a pressure sensor, or an infrared sensor. In some embodiments, a record or indication that the vehicle has departed from the smart zone can be stored or transmitted via the software application in response to detecting that the vehicle has departed from the smart zone.

In some embodiments, during operation of a system for reserving smart zones, a signal is received, via a software application and from a compute device of a user (“requestor”), including a request to reserve a smart zone. The request includes a representation of at least one of a geographic location, a dwell duration, or a smart zone ID for a first smart zone. Based on the request and in response to receiving the request, an availability of the first smart zone is determined. In response to determining that the first smart zone is unavailable, a second smart zone may be identified based on the request, and a signal may be sent to cause display of a representation of the second smart zone to the requestor such that the requestor may accept or decline a reservation of the second smart zone. Alternatively or in addition, a signal may be sent to the compute device of the requestor to alert the requestor that the first smart zone is unavailable.

In some embodiments, during operation of a system for reserving smart zones, a first signal is received, via a software application and from a compute device of a first user (“requestor”), including a first request to reserve a first smart zone, and a second signal is received, via the software application and from a compute device of a second user (“requestor”), including a second request to reserve a second smart zone. Each of the first request and the second request includes a representation of at least one of a geographic location, a dwell duration, or a smart zone ID for a first smart zone. Based on the first request and the second request, and in response to receiving the first request and the second request, an availability of the first smart zone and an availability of the second smart zone are automatically determined. In response to determining that one of the first smart zone or the second smart zone is unavailable, an alternative smart zone may be identified based on the associated request, and a signal may be sent to cause display of a representation of the alternative smart zone to the associated requestor such that that requestor may accept or decline a reservation of the alternative smart zone. Alternatively or in addition, a signal may be sent to the compute device of the requestor to alert the requestor that the requested smart zone is unavailable.

In some such implementations, the system may generate a first invitation to confirm a first reservation and send the first invitation to the compute device of the first user, and may generate a second invitation to confirm a second reservation and send the second invitation to the compute device of the second user. At least one of the first invitation or the second invitation may be generated based on a make, model, or size of the associated requestor's vehicle. At least one of the first invitation or the second invitation may include a smart zone ID that is different from the smart zone ID included with the associated request, a geographic location that is different from the geographic location included with the associated request, and/or a dwell duration that is different from the dwell duration included with the associated request. The first invitation may include a representation of a first portion of a smart zone and the second invitation may include a representation of a second portion of the same smart zone. Alternatively or in addition, the first invitation may include a representation of a first time period and the second invitation may include a representation of a second time period that precedes, that overlaps with, that coincides with, or that occurs after the first time period.

In some embodiments, a system for reserving a smart zone is configured such that a user cannot reserve a smart zone if the user is not within a specified radius (i.e., a “reservation radius”) of the smart zone. In some embodiments, the reservation radius can be no more than about 30 miles, no more than about 25 miles, no more than about 20 miles, no more than about 19 miles, no more than about 18 miles, no more than about 17 miles, no more than about 16 miles, no more than about 15 miles, no more than about 14 miles, no more than about 13 miles, no more than about 12 miles, no more than about 11 miles, no more than about 10 miles, no more than about 9 miles, no more than about 8 miles, no more than about 7 miles, no more than about 6 miles, no more than about 5 miles, no more than about 4 miles, no more than about 3 miles, no more than about 2 miles, no more than about 1 miles, no more than about 0.9 miles, no more than about 0.8 miles, no more than about 0.7 miles, no more than about 0.6 miles, no more than about 0.5 miles, no more than about 0.4 miles, no more than about 0.3 miles, no more than about 0.2 miles, or no more than about 0.1 miles, inclusive of all values and ranges therebetween.

In some embodiments, a system for reserving a smart zone is configured such that a user cannot reserve a smart zone more than a specified time period ahead of the start of the reservation (i.e., a “maximum lead time”). In some embodiments, the maximum lead time can be no more than about 10 hours, no more than about 9 hours, no more than about 8 hours, no more than about 7 hours, no more than about 6 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 25 minutes, no more than about 20 minutes, no more than about 15 minutes, no more than about 10 minutes, no more than about 9 minutes, no more than about 8 minutes, no more than about 7 minutes, no more than about 6 minutes, no more than about 5 minutes, no more than about 4 minutes, no more than about 3 minutes, no more than about 2 minutes, or no more than about 1 minute, inclusive of all values and ranges therebetween.

In some embodiments, a system for reserving a smart zone is configured such that a location of the user or the user's vehicle is detected (e.g., prior to, during, and/or after a hold period), and if the user is not at, or within a predetermined distance of, the smart zone that has been reserved by that user, the reservation is canceled. In some embodiments, detection of the location of the user or the user's vehicle is performed automatically via GPS.

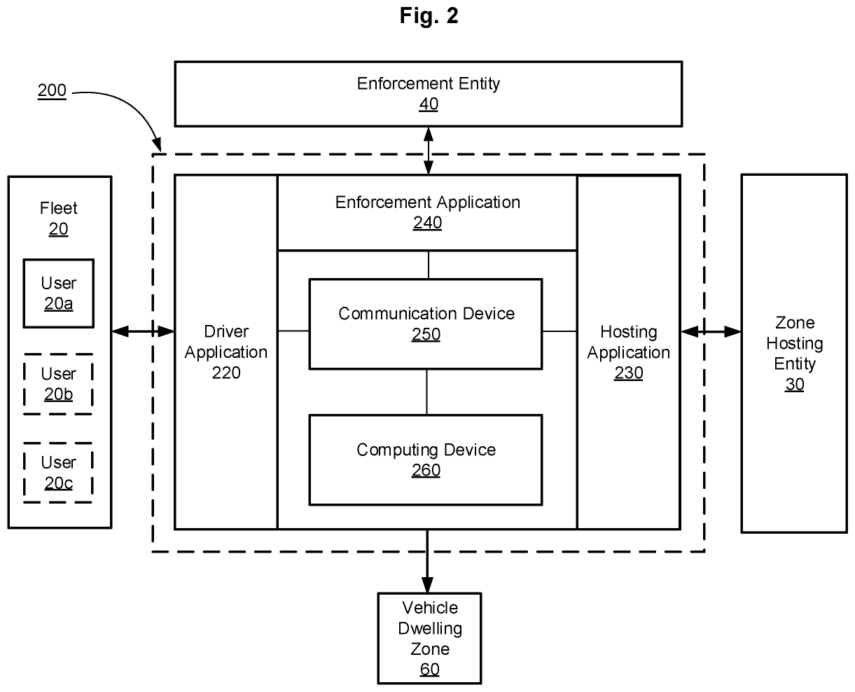

In some embodiments, a system for reserving smart zone is configured such that it is not possible for a smart zone to be double booked. For example, a ledger maintained by a smart zone manager can be authoritative, and the smart zone manager can include or access rules and the ledger to assess compliance and ensure that there is an available space for a vehicle before booking a reservation. In some such implementations, reservations are written to the ledger in a database transaction, and if two transactions try to commit in an “overlapping” fashion, the second transaction is aborted and a notification (e.g., including a request to retry or to revise the request) is sent to the compute device of the user. In other words, when a reservation of a smart zone is requested, and a conflict is identified by the smart zone manager based on the ledger and/or the rules, the user is notified by the smart zone manager, and has the option to request a different smart zone. If a subsequently-selected smart zone is also booked, the retry will fail and a notification may be sent to the compute device of the user to recommend selection of one or more nearby smart zones. FIG. 2 is a flowchart illustrating a smart zone manager 200 and components included in a process of reserving a smart zone, according to an embodiment. As shown, the smart zone manager 200 includes a driver app 220, a hosting app 230, and an enforcement app 240. As shown, the driver app 220, the hosting app 230 and the enforcement app 240 are in communication with a communication device 250, while the communication device 250 is in communication with a computing device 260. In use, a fleet 20 interacts with the driver application, the zone hosting entity 30 interacts with the hosting app 230, and the enforcement entity 40 interacts with the enforcement app 240. Via the smart zone manager 200, the fleet 20, the zone hosting entity 30, and the enforcement entity 40 interact with a vehicle dwelling space 60, or a smart zone. The fleet 20 includes user 20a. In some embodiments, the fleet 20 can include additional users (e.g., user 20b, user 20c).

As noted above, the fleet 20 interacts with the driver app 220. In some embodiments, the driver app 220 can be used to receive the map (i.e., step 11 as described above with reference to FIG. 1). In some embodiments, the driver app 220 can be used to receive the request from the fleet 20, select an available vehicle dwelling zone, and reserve at least a portion of the available vehicle dwelling zone (i.e., steps 13, 14, and 15 as described above with reference to FIG. 1). In some embodiments, the driver app 220 can include a software application. In some embodiments, the driver app 220 can be implemented via a computer, a laptop, a tablet, a mobile device, a mobile phone, or any other suitable software application implementation medium.

The hosting entity 30 interacts with the hosting app 230. As noted above, the hosting entity 30 can include a city, a municipality, a private real estate manager, a land owner, an owner of a space designated as a smart zone, a lessor of a space designated as a smart zone, a school, a university, an airport, a warehouse, a conference center, or any other entity that can host a vehicle dwelling zone. In some embodiments, the hosting app 230 can be used to import a map to the smart zone manager 200. In some embodiments, the hosting app 230 can be used to collaborate with potential partners (i.e., step 12 as described above with reference to FIG. 1). In some embodiments, the hosting app 230 can be involved in selecting an available vehicle dwelling zone and reserving at least a portion of the available vehicle dwelling zone (i.e., steps 14 and 15 as described above with reference to FIG. 1). In some embodiments, the hosting app can be used to regulate usage of vehicle dwelling zones and updating a reservation based on occupancy status of the vehicle dwelling zone (i.e., steps 16 and 17 as described above with reference to FIG. 1). In some embodiments, the zone hosting entity 30 can transmit proposed regulations via the hosting app 230.

The enforcement entity 40 interacts with the enforcement app 240. In some embodiments, the enforcement entity 40 can include a police officer, a traffic enforcement officer, a parking enforcement officer, and/or any specially appointed enforcement officer. In some embodiments, the enforcement app 240 can be used to regulate usage of the vehicle dwelling zone (i.e., step 16 as described above with reference to FIG. 1). In some embodiments, the enforcement entity 40 can transmit notices of fines or other penalties via the enforcement app 240.

The communication device 250 regulates information coming into the smart zone manager 200 and information transmitted from the smart zone manager 200. Any requests and/or notices that come into the smart zone manager 200 via the driver app 220, the hosting app 230, and/or the enforcement app 240 are transmitted to the computing device 260 via the communication device 250. In some embodiments, the communication device 250 can include a cell tower, a satellite, a wired network, a wireless network, and/or any other suitable communication medium. In some embodiments, the computing device 260 can include a data storage medium to store and analyze information transmitted to the smart zone manager 200.

In some embodiments, a method for reserving a vehicle dwelling zone includes receiving a request from a first user via a software application, and selecting (e.g., automatically), via the software application and based on the request, an available vehicle dwelling zone. The vehicle dwelling zone can include, for example, a curb space, an alley space, a private driveway, or a parking garage. The software application reserves (e.g., automatically) at least a portion of the selected vehicle dwelling zone for occupancy of a vehicle, by causing storage, in a memory operably coupled to the software application, of a reservation record including an association between the first user and the selected vehicle dwelling zone. The selected vehicle dwelling zone can have a dimension (e.g., a width or a length) at least about 30 feet. The at least the portion of the selected vehicle dwelling zone can be reserved for a user-configurable hold period of, for example, up to about 10 minutes. A second user can be alerted, via the software application, of the reservation record. The method can also include sending, via the software application and after the reserving, a reservation confirmation message to a compute device of the first user.

In some embodiments, the method also includes sending, via the software application and to an electronic sign adjacent to the vehicle dwelling zone, a signal representing reservation information, for display thereon. In other embodiments, the vehicle dwelling zone does not include any physical signage indicating a status of the vehicle dwelling zone as a reservable vehicle dwelling zone.

In some embodiments, the software application is a first software application, and the processor-implemented method also includes assigning, via a second software application, a first authorized use to the vehicle dwelling zone, for a first time of day, and assigning, via the second software application, a second authorized use to the vehicle dwelling zone, for a second time of day different from the first time of day. The first authorized use can include at least one of goods loading or goods dropoff, and the second authorized use can include at least one of passenger loading or passenger dropoff.

In some embodiments, the method also includes updating a reservation record to remove an association between the first user and the selected vehicle dwelling zone in response to not detecting the vehicle in the selected vehicle dwelling zone during the hold period.

In some embodiments, the method also includes detecting the vehicle in the selected vehicle dwelling zone during the hold period, and in response to the detecting, updating a reservation record to reflect that the selected vehicle dwelling zone has been reserved for a period of time beyond the hold period.

In some embodiments, the reserving includes storing a specified reservation time period as part of the reservation record, and the method also includes extending, via the software application, the reservation time period in response to detecting the vehicle in the vehicle dwelling zone beyond the specified time period.

In some embodiments, the method also includes detecting (e.g., automatically, via GPS) the vehicle in the selected vehicle dwelling zone and one of storing or transmitting, via the software application, an indication that the selected vehicle dwelling zone is occupied.

In some embodiments, the method also includes detecting (e.g., automatically, via GPS) a departure of the vehicle from the selected vehicle dwelling zone and storing, via the software application, an indication that the selected vehicle dwelling zone is unoccupied.

In some embodiments, the method also includes designating, via the software application, an upper limit percentage (e.g., 70%) of the selected vehicle dwelling zone that can be reserved at a given time.

In some embodiments, the method also includes receiving (e.g., from a field enforcement officer) enforcement data and updating an associated reservation record to include the enforcement data.

In some embodiments, the method also includes transmitting to a server, via the software application, data including at least one of a percentage of time or a time period in which the selected vehicle dwelling zone is reserved, and transmitting to the server, via the software application, data including at least one of a percentage of time or a time period in which the selected vehicle dwelling zone is occupied.

In some embodiments, the method also includes transmitting, via the software application, an occupancy payment to an owner of the vehicle dwelling zone.

In some embodiments, the method also includes detecting the available vehicle dwelling zone using at least one of a camera, computer vision or other artificial intelligence (AI) technology, a magnetometer, a pressure sensor, or an infrared sensor. For example, the camera, computer vision or other AI technology, the magnetometer, the pressure sensor, and/or the infrared sensor can be used to detect the presence of, the absence of, the arrival of, and/or the departure of, a vehicle within each vehicle dwelling zone. Alternatively or in addition, one or more of the camera, computer vision or other AI technology, the magnetometer, the pressure sensor, or the infrared sensor can be used to detect a size (height, width, length), weight, shape, make, model, color, passenger occupancy, driver occupancy, distance from a curb or other structure (such as another vehicle), or other parameter(s) of a vehicle within each vehicle dwelling zone.

In some embodiments, the method also includes detecting a dwelling zone violation using at least one of a camera, computer vision, a magnetometer, a pressure sensor, or an infrared sensor.

In some embodiments, the method also includes facilitating a payment transaction for the selected vehicle dwelling zone using at least one of a camera, computer vision, a magnetometer, a pressure sensor, or an infrared sensor.

In some embodiments, the method also includes receiving a wireless signal from a dongle of the vehicle, the wireless signal including an identifier of the vehicle.

In some embodiments, the method also includes facilitating a payment transaction for the selected vehicle dwelling zone via wireless communication with a dongle of the vehicle.

In some embodiments, the method also includes transmitting, to a compute device of at least one of the first user or the second user, and via the software application, real-time information about the selected vehicle dwelling zones. The real-time information can include one of: availability information, price information, terms, conditions, or information about loading zones proximate to the vehicle dwelling zone.

In some embodiments, the method also includes holding, via the software application and based on the request, the available vehicle dwelling zone, by updating a record associated with the selected vehicle dwelling zone in the memory. The holding can occur prior to an arrival of the vehicle at the selected vehicle dwelling zone and the reserving occurs upon detecting arrival of the vehicle at the selected vehicle dwelling zone.

In some embodiments, the selected vehicle dwelling zone is reserved for a time period that is selected by the first user via the software application.

In some embodiments, the selected vehicle dwelling zone is reserved for a time period that is determined automatically based on detecting a presence of the vehicle in the selected vehicle dwelling zone and based on detecting an absence of the vehicle from the selected vehicle dwelling zone.

In some embodiments, the reservation record is a first reservation record, the vehicle is a first vehicle, and the at least a portion of the selected vehicle dwelling zone is a first portion of the selected vehicle dwelling zone, the method also including reserving, via the software application, a second portion of the selected vehicle dwelling zone for occupancy of a second vehicle, by storing, in the memory, a second reservation record including an association between a third user and the selected vehicle dwelling zone.

In some embodiments, a system includes a processor and a memory in communication with the processor. The memory stores processor-executable instructions for reserving a vehicle dwelling zone, the instructions including instructions to cause the processor to receive, via a software application, a request from a first user, and to select, via the software application and based on the request, an available vehicle dwelling zone. The instructions also include instructions to cause the processor to reserve, via the software application, at least a portion of the selected vehicle dwelling zone for occupancy of a vehicle, by storing, in a memory operably coupled to the software application, a reservation record including an association between the first user and the selected vehicle dwelling zone. The instructions also include instructions to cause the processor to alert a second user, via the software application, of the reservation record.

In some embodiments, a non-transitory processor-readable storage medium stores processor-executable instructions for reserving a vehicle dwelling zone. The processor-executable instructions include instructions to cause a processor to receive, via a software application, a request from a first user, and to select, via the software application and based on the request, an available vehicle dwelling zone. The processor-executable instructions also include instructions to cause a processor to reserve, via the software application, at least a portion of the selected vehicle dwelling zone for occupancy of a vehicle, by storing, in a memory operably coupled to the software application, a reservation record including an association between the first user and the selected vehicle dwelling zone, and to alert a second user, via the software application, of the reservation record.

In some embodiments, methods of the present disclosure include automatically generating data over time, via a software application, the data including one or more of reservation data (e.g., reservation times, durations, usages, pricing, vehicle types, etc.), enforcement data (e.g., number of violations, timing of violations, etc.), trend data (e.g., time periods during which the highest numbers of reservations occur, usage prevalence for specified time periods, reservation demand trends, etc.) pricing data, or regulation data. The data can be received via the software app from one or more remote compute devices, user mobile devices, sensors, etc. Based on the automatically generated data, a system can generate (e.g., using a machine learning algorithm) a parking forecast/prediction. Alternatively or in addition, the system can generate a parking usage recommendation/plan, based on the automatically generated data and based on a targeted improvement (e.g., increasing efficiency of vehicle dwelling zone allocation, increasing revenue, increasing user experience rating, etc.). The parking usage recommendation/plan can include recommended changes to one or more of pricing, municipal code, smart zone definitions, etc.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described.

Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

It is intended that the systems and methods described herein can be performed by software (stored in memory and/or executed on hardware), hardware, or a combination thereof. Hardware modules may include, for example, a general-purpose processor, a field programmable gates array (FPGA), and/or an application specific integrated circuit (ASIC). Software modules (executed on hardware) can be expressed in a variety of software languages (e.g., computer code), including Unix utilities, C, C++, Java™, JavaScript, Ruby, SQL, SAS®, Python, Fortran, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code. Each of the devices described herein can include one or more processors as described above.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, solid state storage devices, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Processor-executable instructions can be in many forms, such as program modules, executed by one or more compute devices, and can include routines, programs, objects, components, data structures, and other suitable code that causes a processor to perform particular tasks or implement particular data types, and the functionality can be combined and/or distributed as appropriate for various embodiments.

All definitions, as defined and used herein, should be understood to control over dictionary definitions, definitions in documents incorporated by reference, and/or ordinary meanings of the defined terms.

As used herein, the term “about” and “approximately” generally mean the referenced value plus or minus 10% of the value stated, e.g., about 30 minutes would include 27 minutes to 33 minutes, about 1 hour would include 0.9 hours to 1.1 hours. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A processor-implemented method for reserving a vehicle dwelling zone, the method comprising:
receiving, via a software application, a request from a first user;
selecting, via the software application and based on the request, an available vehicle dwelling zone;
reserving, via the software application, at least a portion of the selected vehicle dwelling zone for occupancy of a vehicle, by storing, in a memory operably coupled to the software application, a reservation record including an association between the first user and the selected vehicle dwelling zone; and
alerting a second user, via the software application, of the reservation record.

2. The processor-implemented method of claim 1, wherein the dimension of the selected vehicle dwelling zone is at least about 30 feet.

3. The processor-implemented method of claim 1, further comprising:
sending, via the software application and to an electronic sign adjacent to the vehicle dwelling zone, a signal representing reservation information, for display thereon.

4. The processor-implemented method of claim 1, wherein the vehicle dwelling zone does not include any physical signage indicating a status of the vehicle dwelling zone as a reservable vehicle dwelling zone.

5. The processor-implemented method of claim 1, wherein the software application is a first software application, the processor-implemented method further comprising:
assigning, via a second software application, a first authorized use to the vehicle dwelling zone, for a first time of day; and
assigning, via the second software application, a second authorized use to the vehicle dwelling zone, for a second time of day different from the first time of day.

6. The processor-implemented method of claim 5, wherein the first authorized use is at least one of goods loading or goods dropoff and the second authorized use is at least one of passenger loading or passenger dropoff.

7. The processor-implemented method of claim 1, further comprising:
sending, via the software application and after the reserving, a reservation confirmation message to a compute device of the first user.

8. The processor-implemented method of claim 1, wherein the at least the portion of the selected vehicle dwelling zone is reserved for a user-configurable hold period of up to about 10 minutes.

9. The processor-implemented method of claim 8, further comprising:
updating a reservation record to remove an association between the first user and the selected vehicle dwelling zone in response to not detecting the vehicle in the selected vehicle dwelling zone during the hold period.

10. The processor-implemented method of claim 8, further comprising:
detecting the vehicle in the selected vehicle dwelling zone during the hold period, and in response to the detecting, updating a reservation record to reflect that the selected vehicle dwelling zone has been reserved for a period of time beyond the hold period.

11. The processor-implemented method of claim 1, wherein the reserving includes storing a specified reservation time period as part of the reservation record, the method further comprising:
extending, via the software application, the reservation time period in response to detecting the vehicle in the vehicle dwelling zone beyond the specified time period.

12. The processor-implemented method of claim 1, further comprising:
detecting the vehicle in the selected vehicle dwelling zone and one of storing or transmitting, via the software application, an indication that the selected vehicle dwelling zone is occupied.

13. The processor-implemented method of claim 12, wherein the detecting is performed automatically via GPS.

14. The processor-implemented method of claim 1, further comprising: detecting a departure of the vehicle from the selected vehicle dwelling zone and storing, via the software application, an indication that the selected vehicle dwelling zone is unoccupied.

15. The processor-implemented method of claim 14, wherein the detecting is performed automatically via GPS.

16. The processor-implemented method of claim 1, further comprising:
designating, via the software application, an upper limit percentage of the selected vehicle dwelling zone that can be reserved at a given time.

17. The processor-implemented method of claim 16, wherein the upper limit percentage is about 70%.

18. The processor-implemented method of claim 1, further comprising:
receiving enforcement data and updating an associated reservation record to include the enforcement data.

19. A system, comprising:
a processor; and
a memory having processor-executable instructions for reserving a vehicle dwelling zone and in communication with the processor, the instructions in the memory comprising instructions for the processor to:
receive, via a software application, a request from a first user;
select, via the software application and based on the request, an available vehicle dwelling zone;
reserve, via the software application, at least a portion of the selected vehicle dwelling zone for occupancy of a vehicle, by storing, in a memory operably coupled to the software application, a reservation record including an association between the first user and the selected vehicle dwelling zone; and
alert a second user, via the software application, of the reservation record.

20. A non-transitory processor-readable storage medium storing processor-executable instructions for reserving a vehicle dwelling zone, the processor-executable instructions comprising instructions to cause a processor to:
receive, via a software application, a request from a first user;
select, via the software application and based on the request, an available vehicle dwelling zone;
reserve, via the software application, at least a portion of the selected vehicle dwelling zone for occupancy of a vehicle, by storing, in a memory operably coupled to the software application, a reservation record including an association between the first user and the selected vehicle dwelling zone; and
alert a second user, via the software application, of the reservation record.
